(19) United States
(12) Patent Application Publication
(10) Pub. No.: US 2014/0053673 A1
(43) Pub. Date: Feb. 27, 2014

(54) ENGAGE LEVER FOR GEARBOX DIRECTLY CONNECTED WITH BEARING BLOCK

(71) Applicants: Hyundai Motor Company, Seoul (KR); SL Corporation, Daegu (KR); Kia Motors Corporation, Seoul (KR)

(72) Inventors: Jee-Hyuck Choi, Hwaseong (KR); Eun-Sik Kim, Daegu (KR); Jeong-Seon Min, Hwasung (KR); Hee-Soo Yang, Hwasung (KR); Bum-Jun Kim, Hwaseong (KR); Yang-Rae Cho, Hwaseong (KR); Sug-Jun Youn, Daegu (KR)

(21) Appl. No.: 13/906,586

(22) Filed: May 31, 2013

(30) Foreign Application Priority Data
Aug. 24, 2012 (KR) 10-2012-0092903

(51) Int. Cl. F16H 59/10

(52) U.S. Cl. CPC F16H 59/10
USPC 74/473.3

(57) ABSTRACT

An engage lever that connects a shift lever and a gear shift cable of a gearbox of a vehicle. The engage lever is directly connected on a body of a bearing block disposed at a lower portion of the engage lever.

### CROSS-REFERENCE TO RELATED APPLICATIONS

This application claims priority under 35 U.S.C. §119 to Korean Patent Application No. 10-2012-0092903, filed on Aug. 24, 2012, in the Korean Intellectual Property Office, the disclosure of which is incorporated herein by reference in its entirety.

### BACKGROUND OF THE INVENTION

1. Field of the Invention

The present invention relates to an engage lever for connecting a shift lever and a gear shift cable of a gearbox of a vehicle, and more particularly, to an engage lever of a gearbox wherein the engage lever is directly connected on a body of a bearing block disposed at a lower portion of the engage lever.

2. Description of the Related Art

In general, an automatic gearbox knob is installed at a side of a driver seat of a vehicle to operate an automatic gearbox of a vehicle. FIG. 1 illustrates a gearbox knob 1 and a lower structure of the gearbox knob 1, wherein the gearbox knob 1 is mounted at a distal end of a lever shaft 2, and the lever shaft 2 is inserted into and fixed to a shift lever 6 installed under a cover 3. Further, an engage lever 4 that connects a gear shift cable (not illustrated) and the corresponding shift lever 6 is mounted at both side surfaces of the shift lever 6.

In the automatic gearbox of the vehicle, when a gear is shifted to park (P), reverse (R), neutral (N), and drive (D) designated by a movement of the gearbox knob 1, the engage lever 4 is coupled with the shift lever 6 and transmits a movement of the gearbox knob 1 to a gear shift cable connected with a gear shift cable connection shaft 5 to enable the gearbox to be shifted.

Moreover, in a manual mode operation of manually operating a gear shift in the automatic gearbox, the engage lever 4 is separated from the shift lever 6 to allow the gear shift cable to fix a current position of drive (D). Furthermore, the movement of the gearbox knob 1 by a driver is transmitted to the shift lever 6, and the transmitted movement is converted into an electric signal by a separate sensing device (e.g., a sensor) that senses the movement of the shift lever 6 and the converted electric signal is transmitted to the gearbox, to perform the gear shift.

FIG. 2 illustrates the shift lever 6 and the engage lever 4 coupled to the shift lever 6 in the related art, and the engage lever 4 includes a first side arm 4-1 coupled to a first side of the shift lever 6 and a second side arm 4-2 coupled to a second side of the shift lever 6, and an upper end of each of the first side arm 4-1 and the second side arm 4-2 forms an integral block. Further, a first hinge 4a formed at a lower end of the first side arm 4-1 and a second hinge 4b formed at a lower end of the second side arm 4-2 are hinge-coupled to the shaft 8 passing through a hinge coupled portion 6a at a lower end of the shift lever 6, to allow the engage lever 4 to be coupled to the shift lever 6.

However, as illustrated in a front view of the lower end of the shift lever 6 of FIG. 3, a spindle bearing (e.g., shaft bearing) 9 passing through and coupled to the shaft 8 is disposed between the first hinge 4a and the second hinge 4b of the engage lever 4, to allow the respective hinge-coupled components to be stacked on the same shaft to be assembled.

Accordingly, dimensional tolerance is generated at three portions, in other words, an interval between the first hinge 4a and a first side of the spindle bearing 9, an interval between the sides of the spindle bearing 9, and an interval between a second side of the spindle bearing 9 and the second hinge 4b, the dimensional tolerance is accumulated based on the amount of use of the gearbox thus, clearance is generated between intervals of the respective components, and the clearance between the respective components operates as a factor of degrading operating feel of the gearbox knob 1, and causing noise during the operation of the gearbox knob 1.

Further, the first hinge 4a and the second hinge 4b of the engage lever 4 and the spindle bearing 9 are assembled on the same shaft, requiring accurate alignment of the respective components during an assembling process, and thus an assembling time is increased.

### SUMMARY

The present invention provides a configuration of an engage lever of a gearbox, which is capable of decreasing noise during an operation of an automatic gearbox of a vehicle, improving operational feel of the gearbox, and improving efficiency of assembly time by reducing dimensional tolerance between respective components generated due to hinge-coupling of a spindle bearing and a first side arm and a second side arm of the engage lever at a lower end portion of a shift lever and minimizing tolerance.

The configuration of the engage lever of the gearbox of the present invention may include a engage lever directly connected on a body of a bearing block included under the engage lever. Accordingly, the effects of the engage lever of the gearbox of the present invention having the aforementioned configuration will be described below.

First, the engage lever of the present invention has a structure in which the engage lever is directly connected to the bearing block, to reduce three portions having dimensional tolerance in the related art to one portion , thereby minimizing clearance between the respective components, and decreasing noise during an operation of an automatic gearbox of the vehicle and improving the operational feel of the gearbox by the minimizing of the clearance.

Second, the engage lever of the present invention has a configuration in which when the engage lever is directly connected with the bearing block, the side arms of the engage lever are assembled with the connection portions of the bearing block, thereby improving efficiency during the assembling of the gearbox lever.

### BRIEF DESCRIPTION OF THE DRAWINGS

FIG. 1 is an exemplary view of a gearbox lever of a vehicle using an engage lever according to the related art;

FIG. 2 is an exemplary view of a state where the engage lever is assembled with a shift lever according to the related art;

FIG. 3 is an exemplary view illustrating a state where the engage lever is assembled with a spindle bearing according to the related art;

FIG. 4 is an exemplary view illustrating a state where an engage lever is assembled with a shift lever according to an exemplary embodiment of the present invention;

FIG. 5 is an exemplary view illustrating a state where the engage lever is coupled with a bearing block according to an exemplary embodiment of the present invention; and

FIGS. 6 and 7 are exemplary views illustrating an assembling process of the engage lever according to an exemplary embodiment of the present invention.

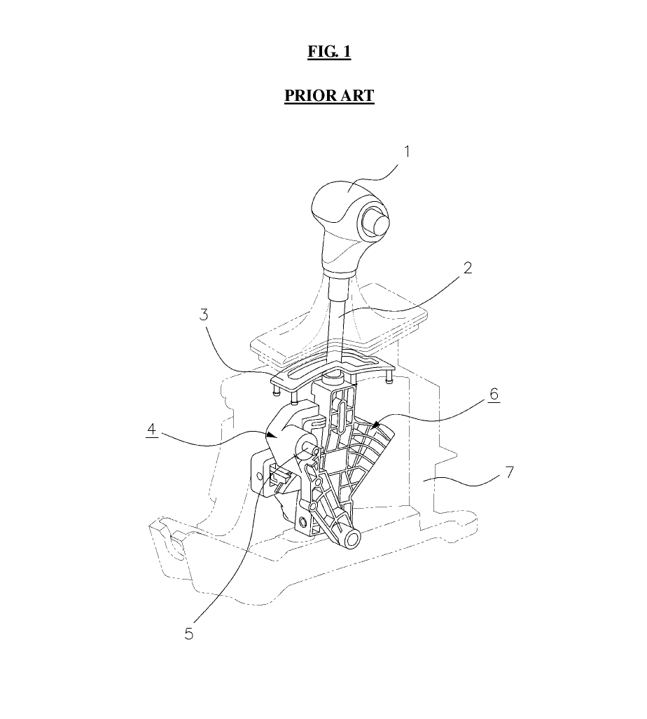

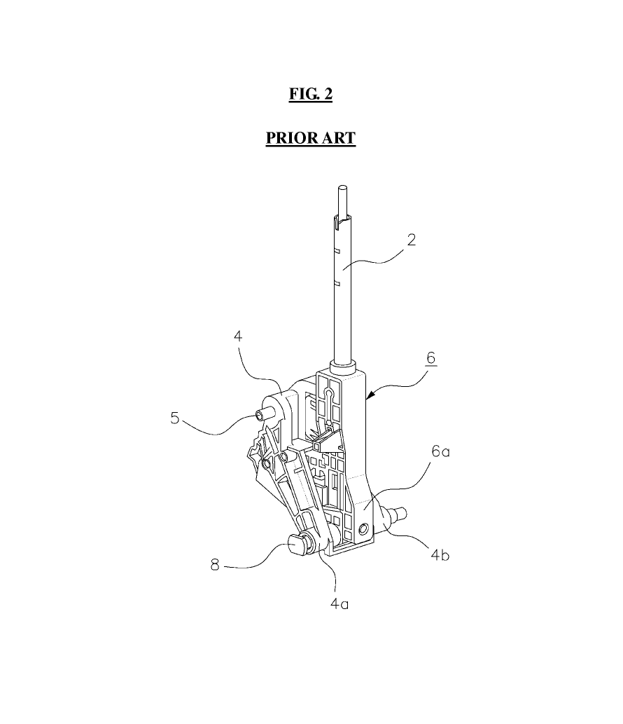

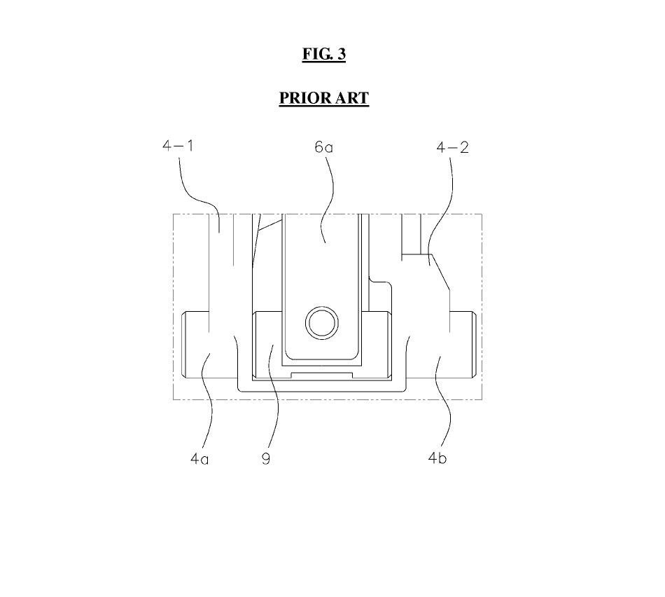

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, a configuration of an engage lever of a gearbox directly connected to a bearing block of the present invention will be described in more detail with reference to the accompanying drawings. However, the disclosed drawings are provided as an example for fully transferring the spirit of the present invention to those skilled in the art. Accordingly, the present invention is not limited to the drawings present below, and may be embodied in other forms.

Further, unless defined to the contrary, terms used in the specification of the present invention have meanings generally understood by those skilled in the art to which the present invention pertains, and in the following description and the accompanying drawings, detailed descriptions of known related functions and configurations may be omitted so as to avoid unnecessarily obscuring the subject matter of the present invention.

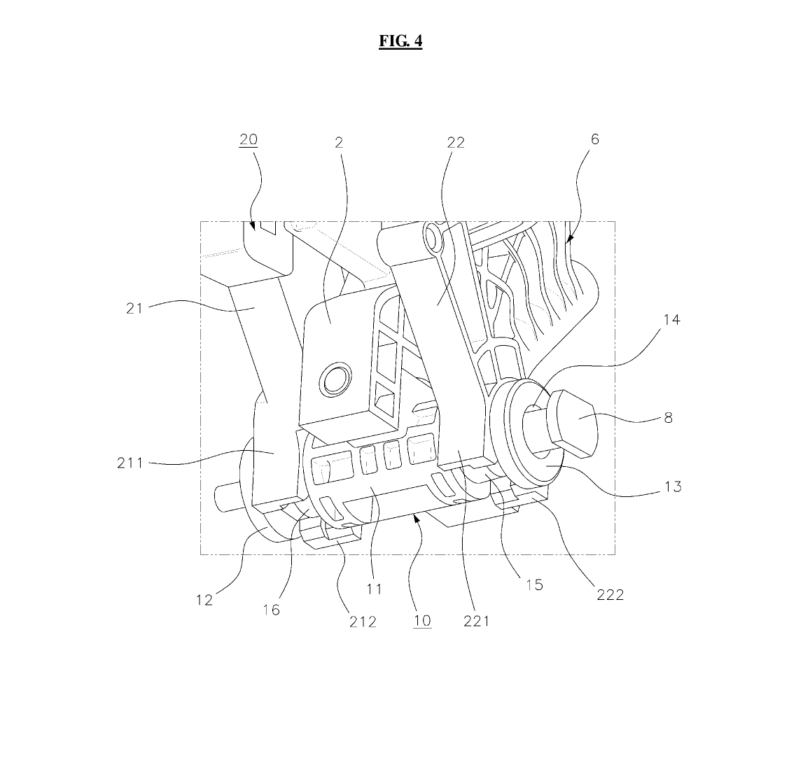

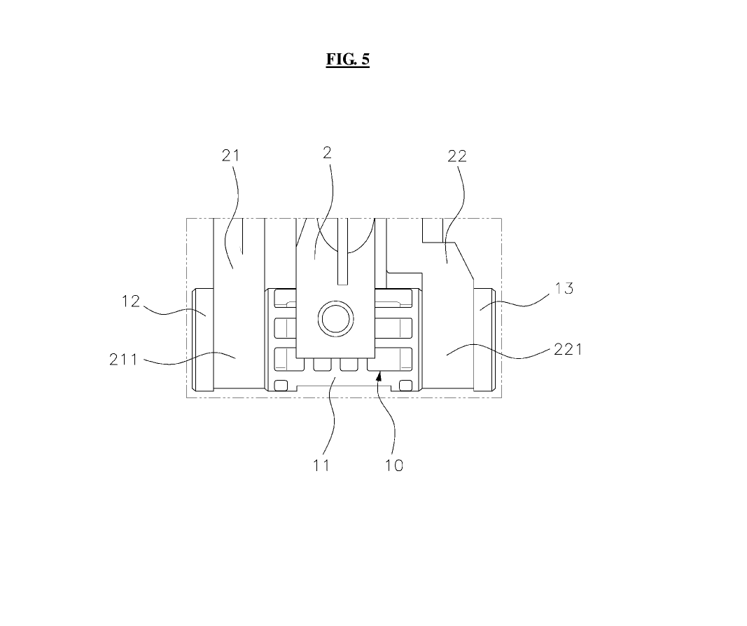

FIG. 4 is an exemplary view illustrating a state where an engage lever is assembled with a shift lever, and FIG. 5 is an exemplary view illustrating a state where the engage lever is coupled with a bearing block. Referring to FIGS. 4 and 5, an engage lever 20 of the present invention has a configuration in which the engage lever 20 is directly connected on a body of a bearing block 10 mounted at a lower portion of the engage lever 20.

More particularly, the bearing block 10 may be a bearing block in which a general bearing, such as a spindle bearing in the related art, is embedded, and may include a center portion 11 operating as the body of the bearing block, a first side connection portion 15 formed at a first side of the center portion 11 to be coupled with a first side arm 21 of the engage lever 20, and a second side connection portion 16 formed at a second side of the center portion 11 to be coupled with a second side arm 22 of the engage lever 20, and a first side flange 12 and a second side flange 13, which forms a jaw surface that prevents the first side arm 21 and the second side arm 22 of the engage lever 20, which are coupled to the first side connection portion 15 and the second side connection portion 16, respectively, from being separated to an external side are formed at external sides of the first side connection portion 15 and the second side connection portion 16, respectively. The center portion 11 corresponding to the body of the bearing block 10 may have a cylindrical shape, and the first side flange 12 and the second side flange 13 may have a ring shape.

The engage lever 20 may have the same structure as an engage lever 22 in the related art, and may include the first side arm 21 coupled to a first side of a shift lever 6 and the second side arm coupled to a second side of the shift lever 6, and an upper end portion of each of the side arms 21, 22 may be integrally formed.

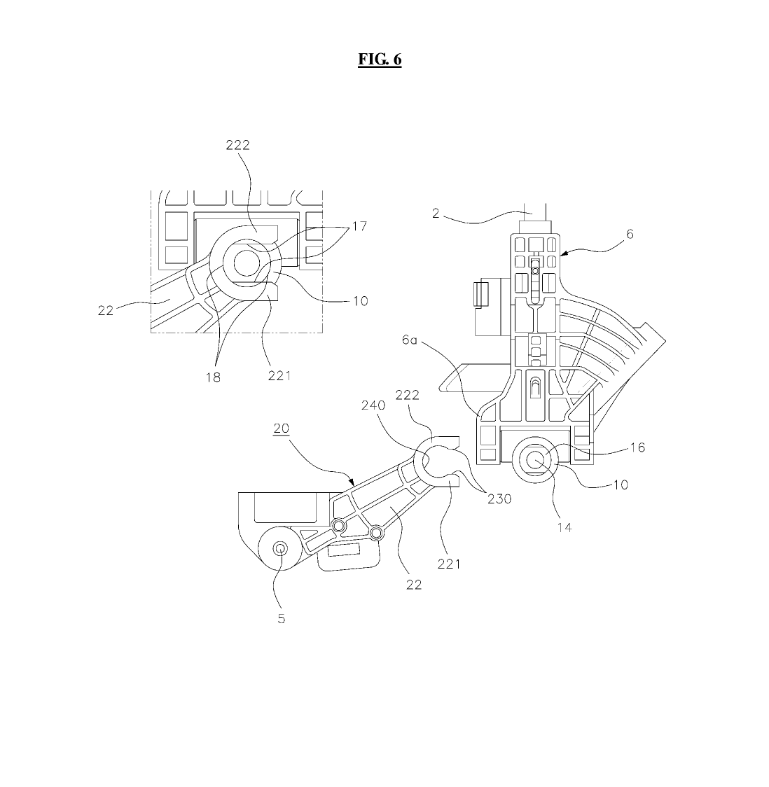

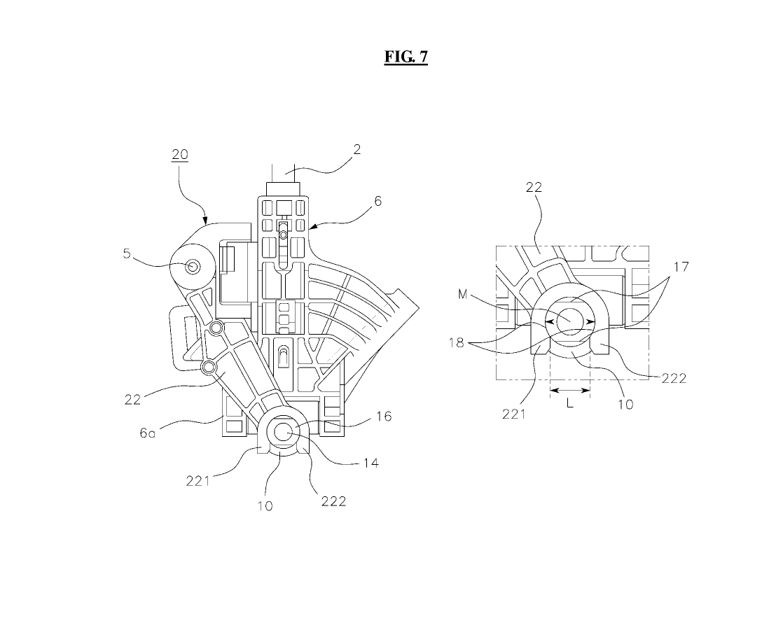

As illustrated in FIGS. 6 and 7, a lower end of the first side arm 21 may include an upper jaw 211 and a lower jaw 212, and distal ends of the upper jaw 211 and the lower jaw 212 may not be connected during an opened state. Further, a lower end of the second side arm 22 may include an upper jaw 221 and a lower jaw 222, and distal ends of the upper jaw 221 and the lower jaw 222 may not be connected during an opened state.

Further, the bearing block 10 of the present invention may include an aperture 14 passing through the center portion 11, the respective connection portions 15 and 16, and the respective flanges 12 and 13, and a shaft 8 may be interpolated in the aperture 14. The bearing block 10 may be attached to a hinge coupled portion 6a formed at a lower end of the shift lever 6. In addition, an attachment method may include general screw coupling or welding coupling, and may be randomly selected based on the shapes and coupling strength of the bearing block 10 and the shift lever 6, thus, a detailed description thereof will be omitted.

Accordingly, in the engage lever 20 of the present invention, a component coupled with the shaft 8 may be the bearing block 10 and a portion in which dimensional tolerance is generated may be reduced to the center portion 11 of the bearing block 10, thus, the dimensional tolerance generated at the three portions in the related art may be reduced. The reduction in dimensional tolerance may decrease clearance between the respective components, thereby decreasing noise and vibration during an operation of a gearbox and improving the operational feel.

FIGS. 6 and 7 are exemplary views illustrating an assembling process of the engage lever of the present invention. Specifically, FIG. 6 is an exemplary view illustrating a state before the engage lever is assembled, and FIG. 7 is an exemplary view illustrating a state after the engage lever is assembled. FIGS. 6 and 7 illustrate a side surface of the second side connection portion 16 of the bearing block 10, and a configuration of the first side connection portion 15 may be substantially the same as the second side connection portion 16 of the bearing block 10.

The engage lever 20 of the present invention including the aforementioned configuration may be coupled to the bearing block 10 attached to a lower end portion of the shift lever 6 coupled to a lever shaft 2. In other words, as illustrated in FIG. 6, an upper surface and a lower surface of the second side connection portion 16 may be formed in planes 17, respectively, and a left side and a right side of the second side connection portion 16 may be formed in cylindrical surfaces 18 having a circular shape, respectively.

Further, the distal ends of the upper jaw 221 and the lower jaw 222 of the second side arm 22 of the engage lever 20 coupled with the second side connection portion 16 may be in the opened state, and internal sides of the opened entrance portions of the upper jaw 221 and the lower jaw 222 may be formed in planes 230, respectively, and internal sides of the remaining portions, except for the entrance portion may be formed in cylindrical surfaces 240 having a circular shape.

Accordingly, when the engage lever 20 is coupled with the shift lever 6, when the portions of the planes 230 of the upper jaw 221 and the lower jaw 222 of the second side arm 22 of the engage lever 20 are aligned to the planes 17 of the upper and lower surfaces of the second side connection portion 16, the second side connection portion 16 may be disposed within the second side connection portion 16 through the opening between the distal ends of the upper jaw 221 and the lower jaw 222. In addition, the cylindrical surfaces 240 formed at the internal sides of the upper jaw 221 and the lower jaw 222 of the second side arm 22 may engage with the cylindrical surfaces 18 of the second side connection portion 16 by rotating an upper block of the engage lever 10 in an upper direction of the shift lever 6, a width L of the opened portion between the upper jaw 221 and the lower jaw 222 of the second side arm 22 may be formed to be less than a length M between the cylindrical surfaces 18 at the left and right sides of the second side connection portion 16, to prevent the upper jaw 221 and the lower jaw 222 of the second side arm 22 from separating from the second side connection portion 16.

Further, a coupling process of the upper jaw 221 and the lower jaw 212 of the first side arm 21 of the engage lever 20 and the first side connection portion 15, and a state thereof may be the same as the aforementioned coupling process and state of the second side arm 22 and the second side connection portion 16, thus, a detailed description thereof will be omitted.

Moreover, the engage lever 20 in the coupled state as described above may be disassembled from the shift lever 6 by performing the aforementioned coupling process in an inverse order.

In the above description, the configuration of the engage lever of the gearbox directly connected to the bearing block of the present invention will be described in detail with reference to the accompanying drawings, but the present invention may be variously modified, changed, and substituted by those skilled in the art, and it shall be construed that the modification, the change, and the substitution belong to the scope of the present invention.

What is claimed is:

1. An engage lever coupled with a shift lever of a vehicle, comprising:
a center portion operating as a body of a bearing block attached to a lower portion of the shift lever;
a first side connection portion formed at a first side of the center portion to be coupled with a first side arm;
a second side connection portion formed at a second side of the center portion to be coupled to a second side arm;
a first side flange and a second side flange shaped like a ring and formed at external sides of the first side connection portion and the second side connection portion, respectively, wherein the first side arm and the second side arm are coupled to the bearing block.

2. The engage lever of claim 1, wherein a lower end of the first side arm includes an upper jaw and a lower jaw, wherein distal ends of the upper jaw and the lower jaw are opened.

3. The engage lever of claim 1, wherein a lower end of the second side arm includes an upper jaw and a lower jaw, wherein distal ends of the upper jaw and the lower jaw are opened.

4. The engage lever of claim 1, wherein upper surfaces and lower surfaces of the first side connection portion and the second side connection portion are planes, respectively, and left sides and right sides thereof are cylindrical surfaces having a circular shape, respectively.

5. The engage lever of claim 4, wherein internal sides of opened entrance portions of the first side arm and the second side arm are planes, respectively, and internal sides of the remaining portions, are cylindrical surfaces having a circular shape.

6. An engage lever coupled with a shift lever of a vehicle, comprising:
a center portion operation as a body of a bearing block attached to a lower portion of the shift lever;
a first side connection portion formed at a first side of the center portion to be coupled with a first side arm;
a second side connection portion formed at a second side of the center portion to be coupled to a second side arm;
a first side flange and a second side flange formed at external sides of the first side connection portion and the second side connection portion, respectively, wherein at least one of the first side arm and the second side arm is coupled to the bearing block.
